(19) United States
(12) Patent Application Publication
(10) Pub. No.: US 2026/0284891 A1
(43) Pub. Date: Sep. 24, 2026

(54) USING MACHINE LEARNING TO ESTIMATE A 3D SHAPE OF OBJECTS

(71) Applicant: Amazon Technologies, Inc., Seattle, WA (US)

(72) Inventors: Hakan Boyraz, Seattle, WA (US); Charles Swan, Renton, WA (US)

(21) Appl. No.: 19/082,949

(22) Filed: Mar. 18, 2025

(51) Int. Cl. B25J 9/16; B25J 19/02; G06V 10/82

(52) U.S. Cl. CPC B25J 9/1697; B25J 9/161; G06V 10/82; B25J 19/023

(57) ABSTRACT

Systems and methods are disclosed for 3D shape estimation of objects to be placed by a robot. The systems may generate features from images that capture an object from different viewpoints. The systems may use machine learning models (e.g., neural networks) to project from a voxel in a set of voxels to distinct portions within the images. The systems may use the machine learning models to generate second features for the voxel based, at least in part, on first features that correspond to the distinct locations. The systems may use the machine learning models to determine whether the voxel indicates the object based, at least in part, on the second features.

### BACKGROUND

Computer vision systems in distribution centers use multiple sensors, such as cameras and depth sensors, to estimate a three dimensional (3D) shape of items. The systems may use those estimations to accurately identify and handle packages of different sizes and forms. For example, the systems may use detailed shape information to guide robotic systems to pick, sort, and store items efficiently. However, processing the large volume of sensor data requires significant computing resources, slowing down system performance and causing delays. Accordingly, there exists a need to solve at least this technical problem and provide additional technical benefits.

### BRIEF DESCRIPTION OF THE DRAWINGS

Various techniques will be described with reference to the drawings, in which:

FIG. 1 illustrates a system to estimate 3D shapes of objects that are to be manipulated by robots, according to at least one embodiment;

FIG. 2 illustrates system to use neural networks to estimate 3D shapes of objects, according to at least one embodiment;

FIG. 3 illustrates a system to train and deploy neural networks, according to at least one embodiment;

FIG. 4 illustrates an example technique to generate features corresponding to a 3D representation, according to at least one embodiment;

FIG. 5 illustrates a process to manipulate objects that enter an area of interest, according to at least one embodiment;

FIG. 6 illustrates a process performed by a processor to use neural networks to estimate 3D shapes of objects, according to at least one embodiment;

FIG. 7 illustrates a process performed by a processor to train neural networks that estimate 3D shapes of objects, according to at least one embodiment; and

FIG. 8 illustrates a system in which various embodiments can be implemented.

### DETAILED DESCRIPTION

Systems and methods are described herein for 3D estimation of objects using computer vision and artificial intelligence (e.g., neural networks, machine learning, machine learning algorithms, machine learning modules). Space carving methods using machine learning models may include capturing numerous images from multiple angles to construct a silhouette, which can be both time-consuming and computationally intensive.

The systems may include an end-of-arm tool (EoAT) with multiple cameras positioned at predetermined or known positions to capture images from different viewpoints, ensuring that neural networks receive sufficient information about the object to perform 3D shape estimation. For example, the cameras may provide diverse perspectives approximately 120° apart to cover as much of the objects as possible. In some examples, an electric motor connected to a support structure of the camera may move the camera to provide different perspectives of the object (e.g., by rotating the camera). Additionally, markers on the robotic arm may help generate position and location information about the object being handled by the robotic arm. The markers may refer to a specific point or feature on a robot used to ensure accurate positioning and alignment during automated processes.

The systems may include image encoders to generate 2D features from captured images, where these features can include sets of tokens representing different regions of the image. The systems may project these features onto a 3D voxel grid and perform feature pooling techniques to compute 3D voxel features. This may include projecting voxel coordinates onto the images and aggregating information from multiple views to form a comprehensive 3D representation. The systems may project the voxel onto each of the images using camera intrinsic and extrinsic parameters. As a result, the systems can map grid cells from images of objects in various perspectives to individual voxels, with each image containing its own grid corresponding to the 3D voxel grid. For example, a voxel maps to cell (x₁,y₁) in a first image, cell (x₂,y₂) in second image, and cell (x₃,y₃) in a third image. Specifically, the systems can perform spatial feature pooling, where 2D features at projected points are aggregated across perspectives to compute the final 3D feature for each voxel. Each voxel in the voxel grid can act as a learnable query in a transformer architecture, represented by its center in 3D space. The systems may compute the visual features for each voxel query using their projected pixel locations in images by at least performing operations like bilinear interpolation of surrounding feature vectors in the corresponding image feature map.

The systems may perform deformable cross-attention and projection-guided attention to generate features for each voxel. For example, performing deformable cross-attention may include selecting a set of sampling points around a reference position, creating a sparse attention map that highlights relevant spatial regions. This can be done to focus on specific areas of the images that are important for understanding the object's shape. In another example, projection-guided attention may include a learned transformation of voxel coordinates combined with learnable query embeddings. A voxel may refer to a 3D unit of space that represents a specific value or property within a digital 3D environment. As a result, the systems may match the 3D positions of these voxels with the visual features from the images.

The systems may use 3D encoders to perform 3D convolutions or self-attention mechanisms, which further process voxel features. 3D encoders update features for a voxel by using features of surrounding voxels. Afterward, the systems can use neural networks, including a multi-layer perceptron, to predict binary occupancy probabilities for each voxel. The neural networks may generate per-voxel occupancy predictions and set a threshold to convert those predictions to generate final binary occupancy prediction. The predictions may indicate whether each voxel is occupied, allowing the systems to use this information to determine the object's 3D shape.

The systems may use a teacher neural network to generate ground truth data from numerous viewpoints, which is then used to train the student neural network that performs 3D shape estimation with fewer viewpoints. The system may use various loss functions to handle class imbalance and improve model convergence. The loss functions may include Binary Cross Entropy Loss (BCE), Focal Loss, and Dice Loss. The system may combine Dice loss and Focal loss for early convergence and better occupancy overlap with ground-truth voxels. Additionally, the system may augment the data to ensure that the student neural network does not overfit to specific parts of the training data. The system may perform image augmentations (e.g., image resizing, random cropping) and update camera intrinsic and extrinsic parameters based on the augmentations made to the images, so that the augmented images and the parameters are used to estimate the 3D shape of the object.

In some examples, a station that uses robots (e.g., End of Arm Tooling, EoAT) to place incoming inventory into storage locations, such as pods or shelves, to make items available for future order fulfillment, receives an object, such as an item or a package. Cameras within the station may capture images after the robot picks it up. The systems send these images to 2D encoders, which generate 2D features. Machine learning models (e.g., neural networks) then may generate features for each voxel of a set of voxels usable for a 3D representation of the object. The machine learning models can do this by using a portion of the 2D features within a region of the image projected from each voxel. The systems may use 3D encoders to update the features for the voxel with other features from neighboring voxels. An occupancy prediction head may determine whether each voxel indicates the object, thereby generating a 3D estimation of the object. Specifically, the prediction may specify whether each voxel is occupied, and the systems can use this information to estimate the object's 3D shape.

The systems can also use this information to estimate the object's orientation, coordinates, and pose relative to the arm holding or grabbing it. For example, the systems can use markers on a robotic arm and known locations (e.g., coordinates) of cameras used to generate images of an object, and the system can use this information to identify a pose, orientation, or position of the object relative to the robotic arm, enabling adjustments for grasping, manipulation, or placement of the object into a particular container in a particular position. As another example, the system can identify a pose as horizontal, vertical, or a combination thereof and use that pose when placing the object inside of a container such that it will not be damaged or touch other objects when at rest The systems can use this 3D estimation to decide which container among a group of containers to move the object to, or which specific location within the container to place the object. The systems can use this 3D estimation to optimize container utilization (e.g., maximizing the number of items per container) while preventing damage and/or collision during placement. The 3D estimation, combined with the object's condition or characteristics (e.g., fragility), can help determine the optimal location or position for placing the item within the container.

In some examples, the systems uses a limited number of 2D projections to accurately determine the full shape of an object. As a result, using the machine learning model and other techniques described herein may enhances memory and processing speed, as it reduces the need for exhaustive 360-degree views. By focusing on fewer viewpoints, the systems may generate precise shape estimates, which are crucial for applications like package handling. This may not only accelerates the determination of shapes on-the-fly but also might minimize the risk of collisions and damage during packaging. The ability to quickly and accurately ascertain the dimensions of items with diverse shapes may ensure optimal packing density, thereby preventing loose packing and enhancing overall efficiency.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure including using machine learning models (e.g., neural networks) to perform 3D shape and pose estimation, certain embodiments may be capable of achieving certain advantages, including some or all of the following: (1) reducing computational load by minimizing the number of camera views required for accurate shape and pose estimation by using neural network architectures like transformers and cross-attention mechanisms to focus on relevant image features; (2) enhancing processing speed and efficiency by using flexible image embedding and feature pooling mechanisms, which allow for precise voxel occupancy predictions with fewer inputs; (3) improving the adaptability of the system to various camera configurations, whether stationary or moving, to capture multiple perspectives efficiently; and (4) optimizing storage and computational resources by accurately determining object dimensions, thus improving packing and placement tasks in automated computer systems., etc.

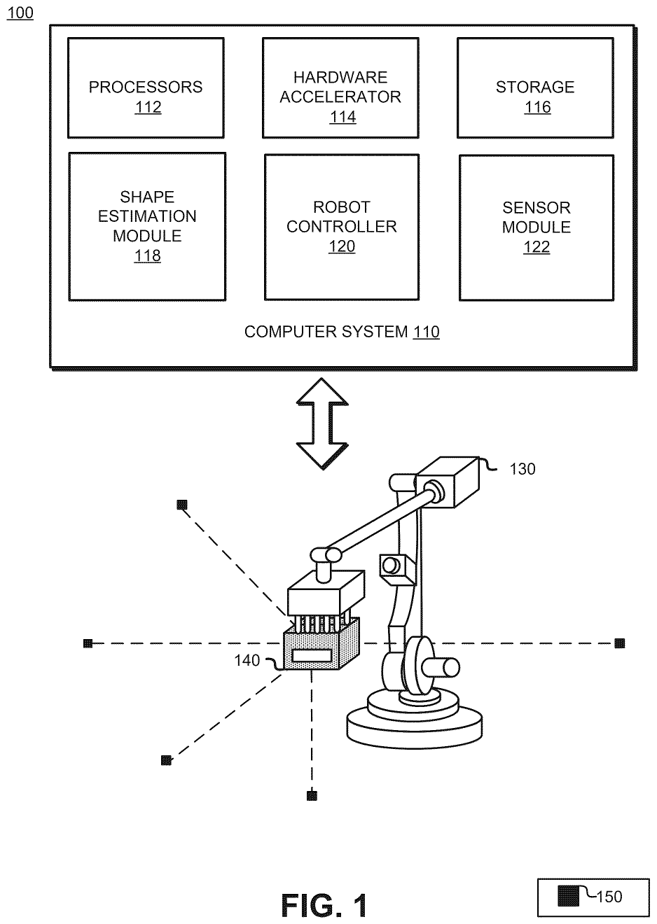

FIG. 1 illustrates environment 100 to examine objects. Environment 100 may include computer system 110, robot 130, object 140, and sensors 150. In at least one embodiment, computer system 110 may include one or more processors 112, one or more hardware accelerators 114, storage 116, shape estimation module 118, robot controller 120, and sensor module 122. In at least one embodiment, computer system 110 can be an edge device physically integrated with a station that includes robot 130 to execute various functionalities (e.g., computer vision, artificial intelligence) as described herein. In some examples, computer system 110 may be cloud-based and connected through various types of network communication (e.g., wireless, wired, or cellular). Components of computer system 110 may be physically integrated with a station that may refer to a designated area where employees or automated systems equipped with robots organize incoming products into storage units, such as pods or shelves, for efficient retrieval during order processing, while other components may be cloud-based and connected via network communication.

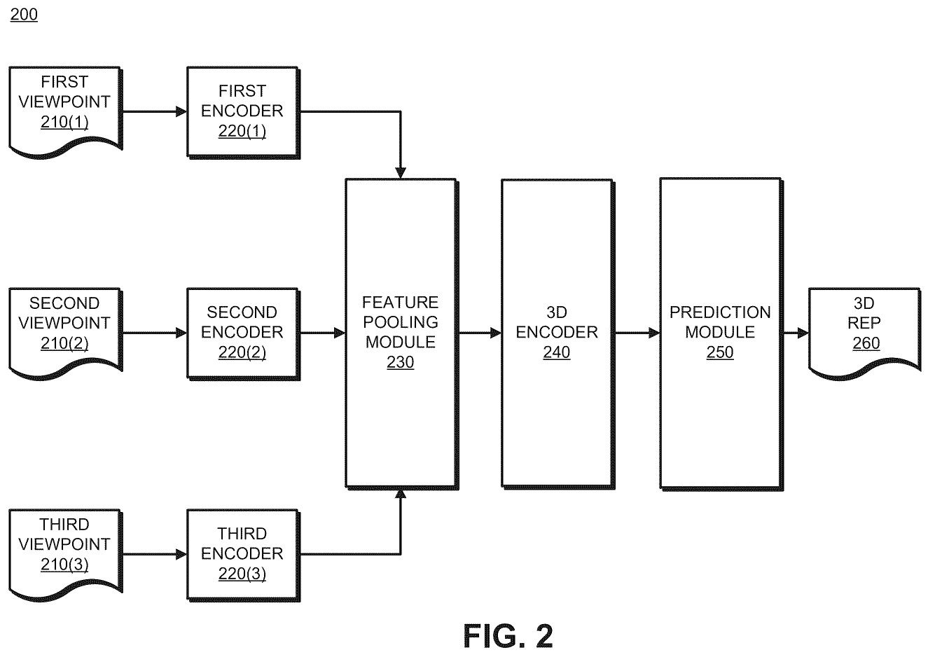

In at least one embodiment, one or more processors 112 may refer to one or more central processing units (CPU) or any other general-purpose processors. Computer system 110 may use one or more processors 112 with one or more hardware accelerators 114 to execute modules such as shape estimation module 118, robot controller 120, and sensor module 122. As used in any implementation described herein, unless otherwise clear from context or stated explicitly to the contrary, terms such as “module” and nominalized verbs (e.g., shape estimation module 118, robot controller 120, and sensor module 122, first encoder 220(1), second encoder 220(2), third encoder 220(3), feature pooling module 230, 3D encoder 240, prediction module 250 illustrated in FIG. 2) illustrated in at least FIGS. 1 and 2 each refer to any combination of software and/or hardware configured to provide specific functionality.

In at least one embodiment, terms such as “software” described herein may include one or more of the following: operating systems, device drivers, application software, database software, graphics software, web browsers, development software (e.g., integrated development environments, code editors, compilers, interpreters), network software, simulation software, real-time operating systems (RTOS), artificial intelligence software, robotics software, firmware (e.g., BIOS/UEFI, router, smartphone, consumer electronics, embedded systems, printer, solid state drive (SSD)), APIs, containerized software, container orchestration platforms, algorithms, instructions, and any other implementation embedded as a software package, code, and/or instruction set.

In at least one embodiment, terms such as “hardware” described herein may include one or more processors 112, one or more hardware accelerators 114, and one or more sensors 150. The “hardware” may further include hardwired circuitry, programmable circuitry, state machine circuitry, fixed function circuitry, execution unit circuitry, and/or firmware that stores instructions executed by programmable circuitry.

In at least one embodiment, one or more hardware accelerators 114 may refer to one or more of specialized hardware units designed to perform specific tasks more efficiently than a general-purpose processor. The one or more hardware accelerators 114 may include one or more of integrated circuit (IC), system on-chip (SoC), graphics processing unit (GPU), data processing unit (DPU), digital signal processor (DSP), tensor processing unit (TPU), accelerated processing unit (APU), application-specific integrated circuits (ASIC), intelligent processing unit (IPU), neural processing unit (NPU), smart network interface controller (SmartNIC), vision processing unit (VPU), field-programmable gate array (FPGA), etc.

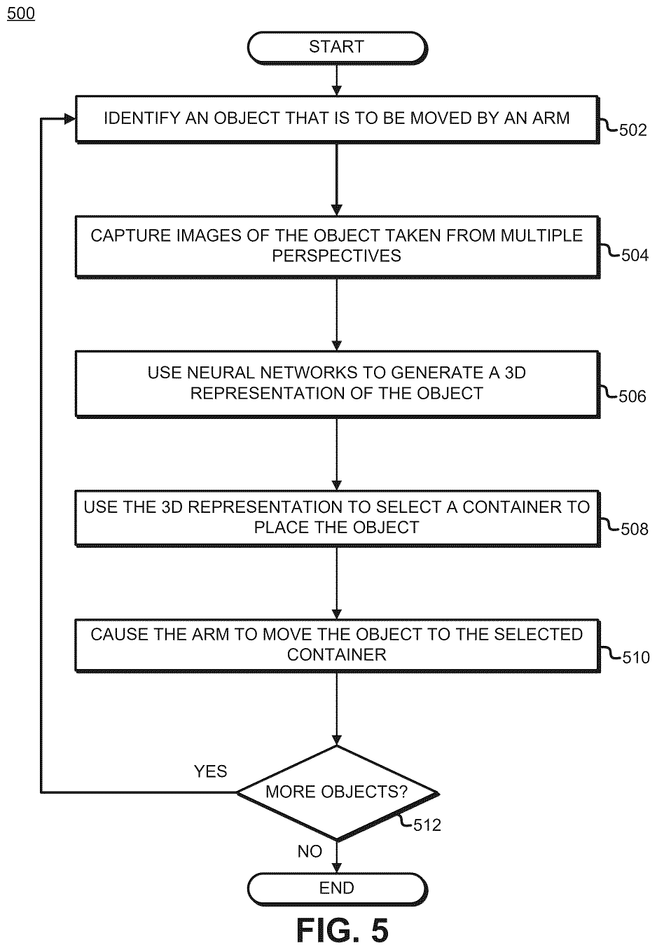

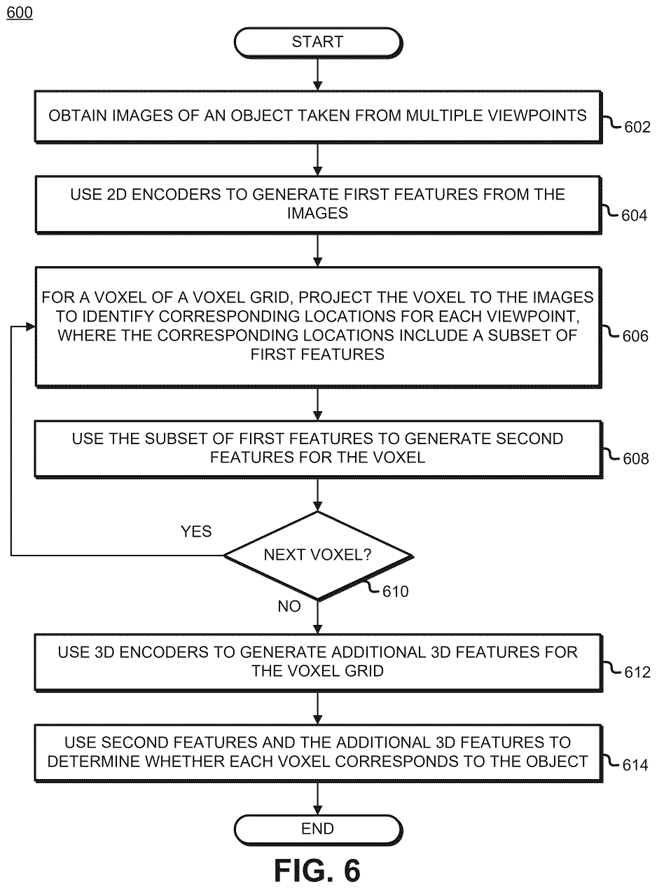

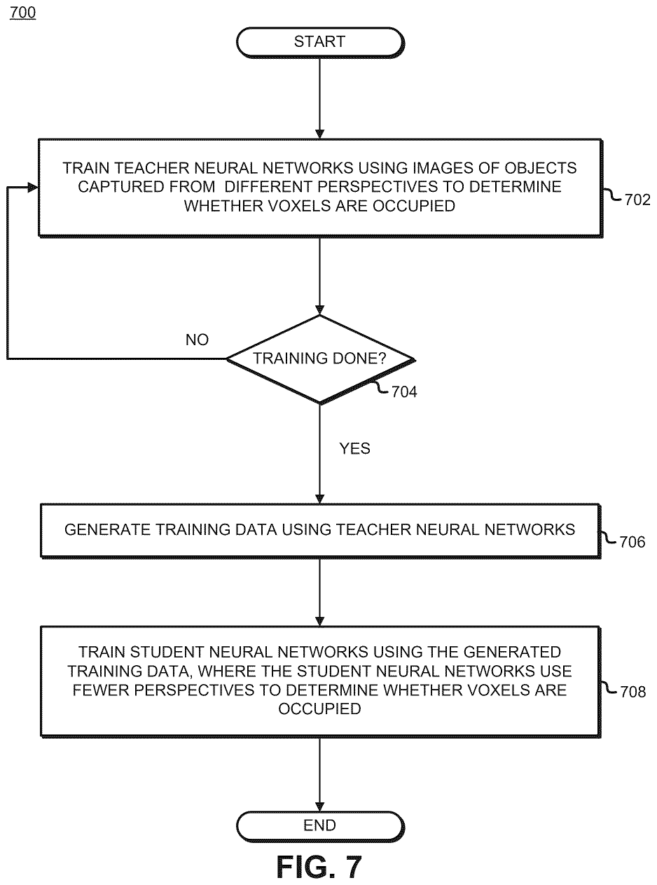

The specific tasks performed by one or more hardware accelerators 114 may include neural network inferencing and training described in conjunction with FIGS. 1, 2 and 4. Shape estimation module 118 and/or sensor module 122 use one or more hardware accelerators 114 for these tasks. For example, neural network inference for the tasks may include image classification, object detection, image segmentation (e.g., semantic segmentation, instance segmentation), image super-resolution, image synthesis and generation, style transfer). Additionally, one or more hardware accelerators 114 may accelerate the performance of one or more blocks of process 500 illustrated in FIG. 5, process 600 illustrated in FIG. 6 and/or process 700 illustrated in FIG. 7.

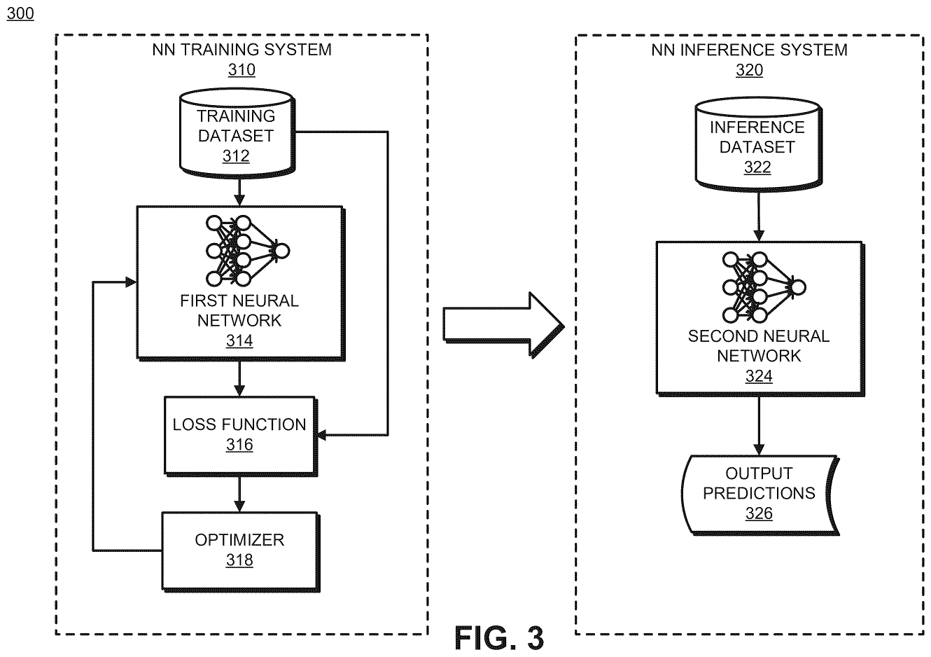

In at least one embodiment, storage 116 may refer to one or more hardware and software components described herein to store, retrieve, and manage data, allowing information to be saved and accessed by one or more entities (e.g., computer system 110, one or more processors 112, one or more hardware accelerators 114, shape estimation module 118, robot controller 120, sensor module 122, system 200 illustrated in FIG. 2, system 300 illustrated in FIG. 3). Storage 116 may include one or more of random access memory (RAM), read-only memory (ROM), flash memory (e.g., Universal Serial Bus (USB) flash drives, SSD, memory cards), cache memory, hard disk drives (HDDs), virtual memory, graphics memory, optical discs, network-attached storage (NAS), cloud storage, tape storage Additionally, the storage may further include one or more of relational databases, NoSQL databases, key-value stores, document-oriented databases, column-family stores, and graph databases. In addition, storage 116 may also include one or more of code repositories, artifact repositories, content repositories, document repositories, package repositories. Furthermore, storage 116 may include one or more of file storage (e.g., network-attached storage (NAS), cloud storage service), block storage, object storage, cache storage, tape storage, etc.

In some examples, storage 116 may store sensor data generated by sensors 150. Storage 116 may store modified sensor data (e.g., images with labels, augmented images) generated by shape estimation module 118. Storage 116 may store neural network training data (e.g., images with ground truth labels) to train the one or more neural networks described herein. Storage 116 may store various 3D representations of objects generated by shape estimation module 118. Storage 116 may include the status of different objects (e.g., which container an object is stored in) and the status of different containers, such as totes.

In at least one embodiment, shape estimation module 118 can be a module to perform 3D shape estimation of objects (e.g., object 140), where the shape estimation can be used to transfer objects between totes using robot 130. Shape estimation module 118 may use a fixed volume around robot 130 with a grid resolution to predict voxel occupancy. Shape estimation module 118 may process images from multiple views and compute 3D voxel features by projecting voxel coordinates onto individual images, attending to 2D features at these projected locations.

Shape estimation module 118 may use one or more neural networks to perform various tasks. The one or more neural networks described throughout FIGS. 1-8 may refer to computational model comprising interconnected nodes (neurons) configured to process input data, identify patterns, and generate outputs based on learned relationships between the data. The one or more neural networks may include convolutional neural networks (CNNs), recurrent neural networks (RNNs), long short-term memory (LSTM) networks, generative adversarial networks (GANs), autoencoders, transformer networks (e.g., bidirectional encoder representations from transformers (BERT), generative pre-trained transformer (GPT), text-to-text transfer transformer (T5), vision transformers (ViT), XLNet, feedforward neural networks. The one or more neural networks may comprise one or more parameters (e.g., one or more weights, one or more biases).

The one or more neural networks may include various image encoders, such as, SwinTransformer, ResNet, and EfficientNet. Shape estimation module 118 can define a voxel grid, centered at the EoAT coordinate frame, with inputs consisting of image views acquired from in-hand cameras and their corresponding camera parameters. The one or more neural networks may predict voxel occupancy (e.g., whether voxel is occupied or not) based on these inputs to estimate 3D shapes and poses of objects. The one or more neural networks may compute visual features for each voxel using their projected pixel locations in images. The one or more neural networks may perform spatial feature pooling or deformable cross-attention, as described in conjunction with FIG. 2, to generate features for each voxel. The cross-attention mechanism may include using each voxel as a learnable query vector and each view as a token. As a result, the one or more neural networks may learn image features and their spatial relationships.

The one or more neural networks may include a 3D encoder that processes 3D voxel features for at least one voxel using 3D convolutions or self-attention mechanisms. The one or more neural networks may also include a Multi-Layer Perceptron (MLP) to process voxel features and predict binary occupancy probabilities. The final output of the one or more neural networks can be a point cloud representation generated based on the determination of whether each voxel in a set corresponds to object 140. Shape estimation module 118 can send the point cloud representation to the robot controller 120, enabling it to direct robot 130 to place object 140 within a container (e.g., tote).

Shape estimation module 118 may use loss functions such as Binary Cross Entropy Loss, Focal Loss, and Dice Loss to train one or more neural networks. The object estimation module 118 may generate training data by setting a volume around robot 130 with a fixed resolution and using point cloud data to generate occupancy labels. Shape estimation module 118 may use one or more teacher neural networks that generate ground truth data from numerous viewpoints, while the neural networks become student neural networks that learn to predict voxel occupancy with fewer images. The ground truth data can be a 3D silhouette generated using various space carving methods that utilize images of objects from many perspectives. Shape estimation module 118 may adjust the weights of the neural networks based on a loss function that compares the student's predictions to the teacher's output. In some embodiments, shape estimation module 118 may include system 200 illustrated in FIG. 2 or system 300 illustrated in FIG. 3.

In at least one embodiment, shape estimation module 118 may include an image processing module that generates and preprocesses (e.g., denoises, downsamples, upsamples, or otherwise modifies) images usable by the shape estimation module 118. The image processing module may receive one or more images or frames from sensor module 122 and modify those images or frames. Modifications may include, for example, resizing, cropping, normalization (e.g., scaling intensity values), augmentation (e.g., rotation, flipping, zooming, shifting, other affine transforms), redistribution of intensity values (e.g., histogram equalization), denoising, enhancement (e.g., increasing brightness, contrast, sharpness), color space conversion, filtering (e.g., Laplacian, Sobel, Gaussian blur), image alignment, scaling (e.g., deep learning super-sampling (DLSS), Xe super-sampling (XeSS), AMD FidelityFX Super Resolution (FSR)), and/or anti-aliasing (e.g., multi-sample anti-aliasing (MSAA), fast approximate anti-aliasing (FXAA), temporal anti-aliasing (TAA), super-sampling anti-aliasing (SSAA), conservative morphological anti-aliasing (CMAA)).

Additionally, the image processing module may generate or modify neural network training data that can be used by the image processing module. For example, the image processing module may generate labels for supervised learning or generate partially labeled data for semi-supervised learning of neural networks. The image processing module may receive indications of ground truth to generate those labels. The image processing module may increase the number of channels of image data by adding time series information to the image data.

In at least one embodiment, portions of the shape estimation module 118 can run locally or in the cloud. For example, neural networks may operate as local models directly connected to or controlling robot 140, enhancing processing speed and reliability during power outages. When using a local version of the shape estimation module 118, a system can generate a shape estimation without waiting for a response from another device in a network, which improves speed at which placement decisions can be made for packages. Alternatively, the shape estimation module 118 can be cloud-based and connected to robot 140 via a network. In an embodiment, the shape estimation module 118 can be performed on an edge server via a network, where said edge server processes shape estimation data closer to the source, reducing latency compared to a fully cloud-based approach while still leveraging computational resources beyond those available on robot 140.

In at least one embodiment, sensor module 122 may refer to a module that controls the one or more sensors (e.g., sensors 150) and one or more lighting elements. The one or more sensors may refer to a device or component that detects, measures, and responds to physical, chemical, or environmental changes, such as temperature, pressure, motion, light, sound, or proximity, and converts this information into signals or data that can be interpreted by sensor module 122. The one or more sensors may may include cameras, color sensors, proximity sensors, distance sensors (e.g., Time of Flight sensor) LiDAR, etc.

In at least one embodiment, sensor module 122 may control the one or more sensors to receive sensor data, such as a set of images that include object 140, captured from different viewpoints using the one or more sensors positioned at various angles. One or more sensors 150 may provide a full 360-degree perspective of object 140. In some examples, one or more sensors 150 can be in fixed locations, allowing images to be captured faster and enabling other components of computer system 110, such as shape estimation module 118, to use the location and position information of one or more sensors 150 for inferencing (e.g., projection of each voxel to portions of various images). In other examples, one or more sensors 150 can be movable, and sensor module 122 can cause them to move so that they can capture object 140 from different perspectives.

In at least one embodiment, the one or more lighting elements may refer to components such as light panels, LED lights, flashlights, or ring lights that are attached to the one or more sensors to provide additional illumination. The one or more lighting elements can enhance image quality by improving lighting in low-light conditions, reducing shadows, and ensuring the subject is well-lit for clearer, sharper photos or videos.

In at least one embodiment, robot 130 may refer to an automated machine that handles, transports, or process object 140 without human intervention within a distribution center. Robot 130 may include EoAT which is an functional interface for interacting with object 140. EoAT may include vacuum grippers which use suction to securely lift and place object 140. EoAT may include mechanical grippers which includes fingers or clamps to grasp object 140. EoAT may include magnetic or electrostatic grippers, which manipulate object 140 with conductive surface. EoAT may include force-torque sensors for adaptive gripping. In some embodiments.

Robot 130 may include sensors for environmental perception, processors for decision-making, and actuators for movement execution. Robot 130 may use sensor data from those sensors to perform decision-making to detect and avoid obstacles. Robot 130 may execute tasks by controlling motors and manipulators to move through environments and interact with objects or containers that store multiple objects. Robot 130 may include communication modules to perform data exchange with other systems (e.g., shape estimation module 118, robot controller 120).

In at least one embodiment, robot controller 120 may refer to a module that directs the functions of various types of robot 130. Robot controller 120 may receive sensor data from sensors 150 and processes this data to generate movement commands, manage obstacle avoidance, and adapt to dynamic conditions surrounding robot 130. The robot controller may include WiFi and Bluetooth for data exchange with robot 130 or the plurality of sensors.

Robot controller 120 may coordinate with the shape estimation module 118 and/or the sensor module 122 to ensure that robot 130 places object 140 in the correct container among other containers. Additionally, even within a selected container, the robot controller 120 may receive 3D shape and pose estimation data of various objects within the container to ensure that robot 130 places object 140 in the correct position or location. Furthermore, robot controller 120 may direct robot 130 to manipulate object 140 into an area of interest so that the sensor module 122 can generate images of object 140 from multiple perspectives, allowing the shape estimation module 118 to use this data to generate 3D shape estimations for object 140. Robot controller 120 may use 3D shape estimation information from the set of voxels described herein to place object 140 it in an exact position to fill up a particular vacant space in the container. Robot controller 120 may use 3D shape estimation information from the set of voxels described herein to place object 140 in an exact position to fill a particular vacant space in the container. Robot controller 120 may compare the space available in the container to the 3D shape and pose estimations. Robot controller 120 may use shape estimation information to arrange one or more objects (which may or may not include object 140) to maximize the number of objects stored within a container, prevent damage to the objects, or minimize wasted space.

Robot controller 120 can use this 3D estimation to optimize container utilization (e.g., maximizing the number of items per container) while preventing damage during placement. The 3D estimation, combined with the object's condition or characteristics (e.g., fragility), can help robot controller 120 to determine the optimal location or position for placing the item within the container. Robot controller 120 may use this 3D estimation to meet packing thresholds (e.g., a specific number of items per container).

In some examples, environment 100 may include a station, such as one that uses robot 130 to place incoming inventory into storage locations, like pods or shelves. Once robot 130 picks up object 140, sensor module 122 may cause one or more sensors 150 to capture object 140 from different perspectives and send the images to shape estimation module 118. Shape estimation module 118 may perform 3D shape estimation of object 140 by using machine learning models to identify, for each voxel, areas within images to identify the corresponding features and use those features, along with additional features (e.g., surrounding features), to generate a feature vector. Shape estimation module 118 may use the machine learning models to determine whether each voxel indicates object 140 to estimate the shape and pose of object 140. Shape estimation module 118 may send the 3D shape and pose estimations to robot controller 120 so that robot controller 120 can decide where or how to place object 140 in a container. Robot controller 120 may also use the shapes of the container or other objects to place object 140 and learn pose of object 140 that robot 130 holds to determine how to place object 140 into the container.

FIG. 2 illustrates system 200 to use neural networks to estimate 3D shapes of objects, according to at least one embodiment. System 200 may include first encoder 220(1), second encoder 220(2), third encoder 220(3), feature pooling module 230, 3D encoder 240, and prediction module 250.

In at least one embodiment, a set of sensors (e.g., cameras) generate one or more images that correspond to first viewpoint 210(1), second viewpoint 210(2), and third viewpoint 210(3). In some examples, the set of sensors may refer to devices that captures and measures properties of light to generate visual or data outputs (e.g., stream of images). the set of sensors may include sensors 150 illustrated in FIG. 1. The set of sensors can generate sensor data that includes a comprehensive view of an object (e.g., object 140 illustrated in FIG. 1). For example, the set of sensors can provide a 360-degree view of the object while it is being manipulated by one or more robots (e.g., robot 130 illustrated in FIG. 1). The set of sensors can include sensors arranged around the object to capture its entirety without rotating the object or any of the sensors. Each sensor can be positioned to focus on a different side of the object, obtaining all perspectives simultaneously. As a result, the sensors can generate a stream of images that captures every angle and detail of the object in a single instance.

In at least one embodiment, one or more images corresponding to first viewpoint 210(1) may become input to first encoder 220(1). One or more images corresponding to second viewpoint 210(2) may become input to second encoder 220(2). One or more images corresponding to third viewpoint 210(3) may become input to third encoder 220(3). In some examples, encoders (e.g., first encoder 220(1), second encoder 220(2), third encoder 220(3)) may refer to neural networks or any other machine learning models that transform input data into a compact latent representation by extracting and preserving discriminative features, such as spatial structures in images, semantic relationships in text, or temporal dependencies in sequential data, for tasks like classification, reconstruction, and generation. Encoders may include EfficientNet, VisionTransformers (ViT), MobileNet, DenseNet, Swin Transformer, VGG, U-Net Encoder, and autoencoders.

In some examples, each decoder (e.g., first encoder 220(1), second encoder 220(2), third encoder 220(3)) may generate a set of tokens from images corresponding to each viewpoint (e.g., first viewpoint 210(1), second viewpoint 210(2), third viewpoint 210(3)), where the set of tokens can be comprised in different regions of the images. Each encoder may send the set of tokens to feature pooling module 230.

In at least one embodiment, feature pooling module 230 can be composed of neural networks or portions of neural networks that generate features corresponding to each voxel in the set of voxels associated with an object (e.g., object 140 illustrated in FIG. 3). In some examples, feature pooling module 230 may include neural networks that perform attention mechanisms (e.g., self-attention, cross-attention). For instance, the feature pooling module 230 may use each voxel in the set of voxels as a learnable query, where each voxel is represented by its center in 3D space. In some examples, feature pooling module 230 can decide whether to use camera parameters or robotic arm markers to guide attention mechanisms, focusing on specific image areas based on the desired processing speed and accuracy.

In some examples, feature pooling module 230 may project each voxel onto the images corresponding to each viewpoint using camera intrinsic and extrinsic parameters. Camera intrinsic parameters may refer to those that define how a camera projects 3D points onto a 2D image plane, including focal length, principal point, and lens distortion coefficients. Camera extrinsic parameters may define the camera's position and orientation in a global coordinate system and may include the rotation matrix, translation vector, and position matrix. In some examples, parameters can be represented as matrices. In some examples, for augmented images, camera intrinsic matrix can be

$${K}^{′} = \begin{matrix}s * {f}_{x} & 0 & s * {c}_{x}^{′} \\ 0 & s * {f}_{y} & s * {c}_{y}^{′} \\ 0 & 0 & 1\end{matrix} ,$$

where

$${c}_{x}^{′} = {c}_{x} - {x}_{crop} and {c}_{y}^{′} = {c}_{y} - {y}_{crop} .$$

Additionally, feature pooling module 230 may use markers or other identifiers located on a robot (e.g., robot 130 illustrated in FIG. 1) to identify additional position or location information for projecting each voxel. In one example, feature pooling module 230 may compute the 2D pixel coordinates of the projected voxel on the i-th camera view by using pᵢ=Kᵢ[Rᵢ|tᵢ]Pᵥ, where (1) Pᵥ is the 3D voxel coordinate (X, Y, Z); (2) Kᵢ is the intrinsic matrix for i-th camera view; (3) Rᵢ is the rotation matrix for i-th camera view; and (4) tᵢ is the translation matrix for i-th camera view.

In at least one embodiment, after projecting each voxel, feature pooling module 230 may compute its feature representation by performing spatial feature pooling. Spatial feature pooling may include feature pooling module 230 aggregating information from multiple image views. Feature pooling module 230 may only aggregate features that are visible in all views. Feature pooling module 230 may compute 2D features at each projected point using bilinear interpolation of surrounding feature vectors in the corresponding feature map. Feature pooling module 230 may compute the final feature vector for the voxel by using

$${f}_{j} = \frac{1}{N} {\sum }_{i = 1}^{N} B ( {F}_{i} , {p}_{ij} ) ,$$

where (1) N can be the number of image views; (2) Fᵢ can be the feature map of the i-th image; (3) B(*, *) may represent bilinear interpolation operation; and (4) pᵢⱼ can be the 2D projection coordinates of voxel j in view i.

In at least one embodiment, feature pooling module 230 may perform deformable cross-attention to generate feature vectors for each voxel, where deformable cross-attention may refer to an attention mechanism that learns sparse, offset-based sampling locations to adaptively focus on pertinent regions across multi-scale feature maps. This may include using learnable offset vectors for each query element to determine a sparse set of sampling locations within multi-scale feature maps. These vectors may direct attention layers to a handful of spatial positions rather than every location. Feature pooling module 230 may compute the attention weights at these sampled points and then aggregated to produce the final attended feature. Feature pooling module 230 may cause cross-attention to be performed at a specific locations of the images by at least using

$${f}_{j} = DeformableAttention ( {q}_{j} , {\{ {F}_{i} , {p}_{ij} \}}_{i = 1}^{N} ) ,$$

where (1) N can be the number of image views; (2) Fᵢ can be the feature map of the i-th image; (3) qⱼ can be the query vector for the j-th voxel; and (4) pᵢⱼ can be the 2D projection coordinates of voxel j in view i.

In at least one embodiment, feature pooling module 230 may perform projection guided cross-attention to generate feature vectors for each voxel. Feature pooling module 230 may perform qⱼ=[wᵢⱼpᵢⱼ,eⱼ], where (1) pᵢⱼ may represent the coordinates of the j-th voxel on the i-th image; (2) Wᵢⱼ can be the learned linear project matrix for the j-th voxel on the i-th image; (3) eⱼ can be the learnable 3D voxel query embedding; and (4) [⋅;⋅] can denotes point-wise sum operation. feature pooling module 230 may perform fᵢⱼ=CrossAttention(qⱼ, Kⱼ, Vᵢ), where (1) fᵢⱼ can be the feature vector for the j-th voxel on the i-th image; (2) Kⱼ can be the key derived from the visual features for the i-th image; and (3) Vᵢ can be the values derived from the visual features for the i-th image. Feature pooling module 230 may perform

$${f}_{j} = \frac{1}{N} {\sum }_{i = 1}^{N} {f}_{ij} ,$$

where (1) fᵢⱼ can be the feature vector for the j-th voxel on the i-th image; and (2) fⱼ can be the resulting vector for the j-th voxel. Feature pooling module 230 may employ a learned transformation of voxel coordinates combined with learnable query embeddings. Feature pooling module 230 may specifically project each voxel's coordinates through a learned linear mapping and concatenate the result with learnable query vectors. Feature pooling module 230 may then compute the feature vector for each voxel through cross-attention between these enhanced queries and the visual features.

In at least one embodiment, after generating final feature vectors for each voxel using various techniques described herein, 3D encoder 240 may generate additional features or updated features or both for at least one voxel within the voxel grid, where 3D encoder 240 may refer to a model that generates a latent representation that captures relevant geometric and structural features. In some examples, 3D encoder 240 may include convolutional 3D, VoxelNEt, MinkowskiNet, PointNet, and 3D U-Net. For one or more voxels, 3D encoder 240 may perform cross-attention to identify the feature vectors of surrounding voxels to update the feature vectors corresponding to those voxels.

In at least one embodiment, prediction module 250 may receive feature vectors generated from feature pooling module 230 or 3D encoder 240 or both. Prediction module 250 may include a Multi-Layer Perceptron (MLP) that processes feature vectors to predict binary occupancy probabilities. The MLP may perform p(oⱼ)=σ(MLP(fⱼ)), where (1) fⱼ can be the processed feature vector for the j-th voxel; (2) MLP(⋅) can be the multi-layer perceptron network; (3) σ(⋅) can be the sigmoid activation function; and (4) p(oⱼ)∈[0,1] represents the probability of voxel j being occupied. Prediction module 250 may produce a per-voxel occupancy prediction. Prediction module 250 may transform the learned feature representations to a desired 3D shape estimation output 260. 3D shape estimation output may also indicate pose, orientation, and coordinates of the item, where indication can be based on the robotic arm holding the item. Prediction module 250 may determine that a voxel corresponds to a portion of the object if the predicted probability exceeds a certain threshold. 3D shape estimation output 260 can be in different forms such as mesh graph representations, skeleton-based representations, scene graphs, surface-based representations (e.g., polygon meshes, subdivision surfaces, parametric surfaces), volume-based representations (e.g., signed distance field, octrees, point clouds), among others.

In some examples, octree-based optimization can be performed to educing memory usage and computational overhead of 3D shape estimation output 260. Specifically, additional software (not explicitly illustrated in FIG. 2) can hierarchically partitions the 3D space into progressively smaller regions using an octree structure. The software may define the entire voxel grid as a single root node. If this region contains both occupied and empty voxels, the software may subdivides the space into eight smaller cubes (octants). The software may analyzes each octant: discarding fully empty regions, storing fully occupied regions as single nodes, and recursively subdividing partially occupied regions until it reaches the desired level of detail.

In some examples, prediction module 250 can apply varying thresholds across different areas of the voxel grid. For voxels near the object's surface, where higher resolution is necessary, a higher threshold probability can be used to determine occupancy. Conversely, areas not requiring high resolution can have a lower threshold. Additionally, the number of voxels representing the surface or other critical sections can be increased to enhance resolution in those specific parts of the object.

In at least one embodiment, one or more entities, such as neural network (NN) training system 310 illustrated in FIG. 3 may train one or more encoders (e.g., first encoder 220(1), second encoder 220(2), third encoder 220(3)), feature pooling module 230, 3D encoder 240, and/or prediction module 250. The one or more entities may use loss functions, such as binary cross entropy loss, focal loss (e.g., L_{focal}=Σⱼ[yⱼ(1−p(Oⱼ))^{Y} log(p(Oⱼ))+(1−yⱼ)p(Oⱼ)^{Y} log(1−p(Oⱼ))]), dice loss

$$( e . g . , {L}_{focal} = 1 - \frac{2 {\sum }_{j} {y}_{j} p ( {O}_{j} )}{{\sum }_{j} {p ( {O}_{j} )}^{2} + {\sum }_{j} {y}_{j}^{2}} ) ,$$

and a combination of dice loss and focal loss to train the components of system 200. The one or more entities may train a teacher neural network to predict occupancy for each voxel using images with additional perspectives of the object and use that to train the components of system 200, which are treated as student neural networks. The one or more entities may compare the predictions of the teacher neural network with the output of the components of system 200 to determine the loss for updating the components. In some examples, one or more neural networks of system 200 (e.g., first encoder 220(1), second encoder 220(2), third encoder 220(3), feature pooling module 230, 3D encoder 240, prediction module 250) can run locally on a robot's processors or be deployed in the cloud.

FIG. 3 illustrates a system to train and deploy neural networks, according to at least one embodiment. System 300 may include a distributed system may refer to a network of independent computers that coordinate to achieve common functionality (e.g., neural network training, neural network inferencing). System 300 may include nodes connected via communication protocols, data distribution methods, and synchronization mechanisms. The nodes may execute processes concurrently across different machines, exchanging messages and replicating data. System 300 may perform load balancing and fault detection operate to manage resources and ensure system reliability. Alternatively, system 300 may include a single computer or a server that manages and controls all operations.

In at least one embodiment, system 300 may include neural network training system 310 and neural network inference system 320. Neural network training system 310 may refer to one or more of software and hardware described in conjunction with FIG. 1 to train one or more neural networks described herein. Neural network training system 310 may include frameworks such as TensorFlow, PyTorch, Keras, MXNet, Caffe, Theano, etc. Neural network training system 310 may include using one or more hardware accelerators described herein (e.g., GPUs) to acclerator one or more portions to train neural network such as, first neural network 314. First neural network 314 may include the one or more neural networks described in conjunction with FIG. 1 and/or FIG. 2.

In at least one embodiment, neural network training system 310 may normalize and transform input data, such as training dataset 312. Neural network training system 310 may perform data normalization processes that scale feature values to a standard range, such as min-max scaling or z-score normalization. Neural network training system 310 may generate additional training samples to be added to training dataset 312 through transformations like rotation, flipping, or cropping. Neural network training system 310 may perform feature extraction operations, extracting relevant attributes from raw data, and feature selection, identifying the most significant features for first neural network 314. Neural network training system 310 may remove noise, address missing values, perform data cleaning tasks for training dataset 312.

In at least one embodiment, neural network training system 310 define the layers and connections of first neural network 314. Neural network training system 310 may determine the type of each layer, such as convolutional, recurrent, or fully connected layers, and set parameters like the number of neurons or filters. Neural network training system 310 may assign specific activation functions, such as ReLU or sigmoid, to each layer to introduce non-linearity. Neural network training system 310 may establishes connection patterns by configuring how layers interact, including sequential arrangements, skip connections, or branching paths. Neural network training system 310 may define inputs and output layers to ensure appropriate data flow through first neural network 314. Neural network training system 310 initialize weights and biases for each connection, setting initial values that influence the training process. In some examples, initializing of weights and biases may include (1) Zero Initialization, which sets all weights to zero; (2) random Initialization, where weights are set to small random values; (3) Glorot Initialization that adjusts the scale of the weights according to the number of input and output neurons; and (4) He Initialization that sets weights with a variance scaled by the number of input neurons.

In at least one embodiment, first neural network 314 may refer to the one or more neural networks described in conjunction with FIG. 1. In some examples, first neural network 314 may include a untrained neural network, which may refer to a neural network architecture that has been initialized but not yet exposed to any training data. In various examples, first neural network 314 may include pre-trained neural networks, such as VGG, ResNet, GoogleNet, EfficientNEt, YOLO, BERT, GPT, T5, ROBERTa, XLNet, DeepSpeech, Wav2Vec, Jasper, AlphaZero, StyleGAN, etc. In other examples, first neural network 314 may include second neural network 324 that is already trained.

In at least one embodiment, training dataset 312 may refer to a collection of labeled or unlabeled data used to train first neural network 314. Training dataset 312 may include input samples, which represent the features or attributes that the neural network processes, and corresponding target outputs, which first neural network 314 aims to predict. Training dataset 312 may include batches or mini-batches. Training dataset 312 may include various data formats, such as images, text, or numerical data, by structuring the data in formats compatible with the input layer of first neural network 314. Additionally, training dataset 312 may include metadata that provides information about the data sources, labeling schemes, and any preprocessing steps applied, as noted above. In some examples, there can be one or more neural networks (separate from first neural network 314) that generates training dataset 312. For example, the one or more neural networks may include Generative Adversarial Networks (GANs) or Variational Autoencoders (VAEs) that mimic the characteristics of a genuine dataset. In other examples, one or more teacher neural networks can generate predicted labels, intermediate feature representations, or synthetic samples to encapsulate learned patterns of the one or more teacher neural networks. The generated information can be part of training dataset 312, which is used to train the first neural network 314, transforming it into a student neural network. In some examples, the one or more teacher neural networks are trained using more viewpoints compared to those used to train first neural network 314.

In at least one embodiment, neural network training system 310 performs forward pass using training dataset 312. The forward pass may refer to a process where input data from training dataset 312 propagates through first neural network 314 to generate output predictions. The forward pass may include feeding input samples into the input layer of first neural network 314, sequentially passing data through each hidden layer of first neural network 314 by applying the defined activation functions, and producing outputs in the output layer of first neural network 314. Neural network training system 310 may process each layer's computations by performing matrix multiplications with weights, adding biases, and applying activation functions to introduce non-linearity.

In at least one embodiment, neural network training system 310 uses loss function 316 to evaluate discrepancy between the output predictions and actual target values from training dataset 312 generated during the forward pass. Loss function 316 may include mechanisms for calculating the difference using specific mathematical formulations, such as mean squared error for regression tasks or cross-entropy loss for classification tasks. Loss function 316 can include aggregations of individual errors across the training samples to produce a single scalar value representing the overall performance of first neural network 314.

In at least one embodiment, optimizer 318 may refer to a computational component that adjusts weights and biases of first neural network 314 to minimize loss function 316. Optimizer 318 may include algorithms such as stochastic gradient descent (SGD), Adam, and RMSprop, each implementing specific strategies for updating parameters based on calculated gradients. Optimizer 318 may calculate gradients of loss function 316 with respect to each parameter by applying backpropagation, determining the direction and magnitude of adjustments needed. Optimizer 318 may manage learning rates, which control the step size of each update, and may incorporate techniques like momentum to accelerate convergence by considering past gradient information. Optimizer 318 may perform adaptive learning rate adjustments and allow different parameters to be updated at varying rates based on their individual gradient histories. Optimizer 318 may execute iterative update rules during each training epoch, systematically refining parameters of first neural network 314 to progressively reduce the loss and improve the performance of first neural network 314 on training dataset 312.

In at least one embodiment, neural network training system 310 may perform training in a supervised, partially supervised, or unsupervised manner. Neural network training system 310 may perform federated learning, where multiple decentralized devices or servers collaboratively train first neural network 314 while keeping the training data (e.g., portions of training dataset 312) localized.

In at least one embodiment, neural network training system 310 may perform fine tuning of first neural network 314. Fine tuning may refer to performing additional training on a new, often more specific dataset to adapt its parameters for a particular task. Fine tuning may include loading the pre-trained weights and biases into the architecture of first neural network 314, selecting specific layers of first neural network 314 to update while freezing others to retain previously learned features. Fine tuning may include reinitializing certain layers of first neural network 314 if necessary and applying regularization techniques to prevent overfitting during the subsequent training phases. Fine tuning may include configuring a lower learning rate to make subtle adjustments to the parameters first neural network 314 of to ensure that the existing knowledge is preserved while accommodating new information.

In at least one embodiment, neural network training system 310 may perform the iterative process until first neural network 314 achieves a desired accuracy. For example, neural network training system 310 may evaluate first neural network 314 using a test or validation set and the accuracy can be the ratio of correctly predicted labels. In some examples, accuracy of first neural network 314 may depend on the final loss on the test or validation set. After determining that the desired accuracy is met, first neural network 314 becomes second neural network 324. In some examples, second neural network 324 may refer to one or more neural networks described in conjunction with FIGS. 1 and 2.

In at least one embodiment, neural network inference system 320 may refer to a framework that executes trained neural network models, such as second neural network 324 to generate output predictions 526 based on new input data, such as inference dataset 322. Neural network inference system 320 may load and initialize parameters (e.g., weights, biases) of second neural network 324 into the runtime environment. Neural network inference system 320 feeds inference dataset 322 to input layer of second neural network 324, where values are generated and propagated through one or more layers of second neural network 324 and output predictions 526 are generated. In some examples, inference dataset 322 may include images, videos, text, audio, etc. inference dataset 322 may include synthetic data generated by neural networks (e.g., GAN) other than second neural network 324.

In at least one embodiment, neural network inference system 320 may include cloud servers or edge devices to deploy second neural network 324. Neural network inference system 520 may include cores, devices, inference chips, GPUs to generate activations to further generate output predictions 326. Output predictions 326 may include classification labels, probability distributions, continuous numerical values, sequences, images, translations, embeddings, actions, structured data outputs, audio, heatmaps, attention maps, generative content, etc.

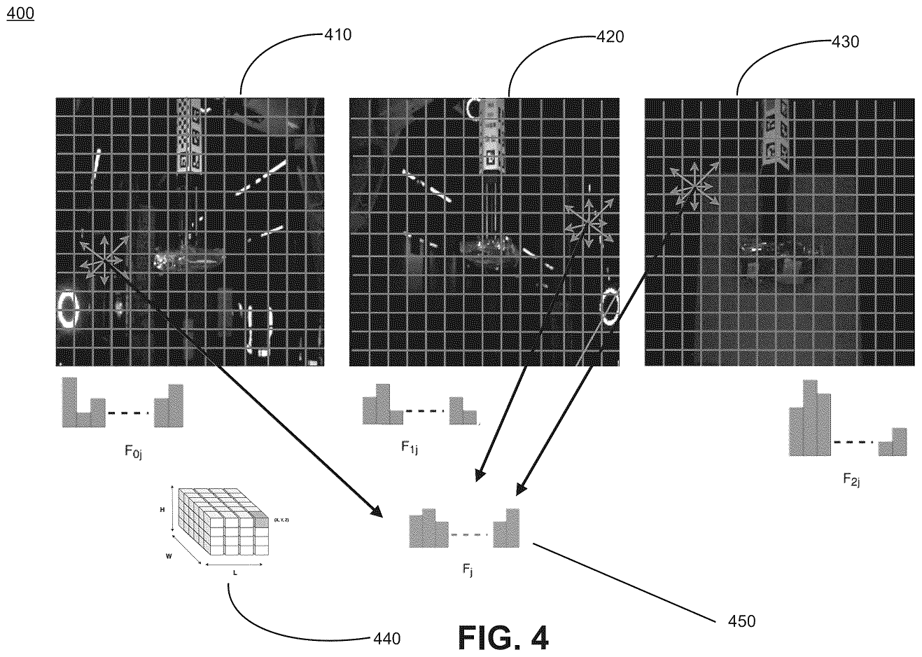

FIG. 4 illustrates an example technique 400 to generate features corresponding to a 3D representation, in accordance with at least one embodiment. Each representation (e.g., first representation 410, second representation 420, third representation 430) may correspond to different viewpoints of an object (e.g., object 140 illustrated in FIG. 1). Each representation may include feature maps generated by 2D encoders described herein (e.g., first encoder 220(1), second encoder 220(2), third encoder 220(3)).

In at least one embodiment, first representation 410 may include one or more first subsets of features (e.g., Fₒⱼ) that correspond to a voxel of a voxel grid 440. Second representation 420 may include one or more second subsets of features (e.g., F₁ⱼ) that correspond to a voxel of the voxel grid 440. Third representation 430 may include one or more third subsets of features (e.g., F₂ⱼ) that correspond to a voxel of voxel grid 440. One or more systems or modules (e.g., shape estimation module 118 illustrated in FIG. 1, feature pooling module 230 illustrated in FIG. 2) may perform various techniques described in conjunction with FIGS. 1, 2, 5, and 6 to project from the voxel of the voxel grid 440 to the one or more first subsets of features, one or more second subsets of features, and one or more third subsets of features. The systems or modules may use camera intrinsic and/or extrinsic parameters for projection. The systems or modules may perform cross-attention operations for projection.

In some examples, voxel grid 440 can be dynamic and change over time. Specifically, for complex objects, the grid may include finer-scale voxels to capture more intricate details. Systems may adjust the required detail or resolution of the 3D shape and pose estimation based on factors such as the sufficiency of detail for downstream operations (e.g., placing the object), computing resource constraints, and time constraints.

In at least one embodiment, the one or more systems or modules may identify surrounding features (indicated by arrows spreading from a center of a grid of the first representation 410, second representation 420, and third representation 430) of each of the one or more first subsets of features, one or more second subsets of features, and one or more third subsets of features to generate one or more feature vectors 450 for the voxel of the voxel grid 440. The process can repeat for every voxel of the voxel grid 440 by using first representation 410, second representation 420, and third representation 430. The one or more systems or modules may use feature vectors 450 to predict voxel grid occupancy, generating a 3D estimation of the object's shape, pose, coordinates, and orientation. This 3D estimation can help robotic systems improve item-per-container ratios and minimize collisions during placement or among items.

FIG. 5 illustrates process 500 to manipulate objects that enter an area of interest, according to at least one embodiment. Although process 500 is depicted as a series of steps or operations, it will be appreciated that at least one embodiment of process 500 includes altered or reordered steps or operations, or omits certain steps or operations, except where explicitly noted or logically required, such as when an output of one step or operation is used as input for another. One or more entities described in conjunction with FIGS. 1-4 and 8, singly or in any combination, can perform each block of process 500. For example, the one or more entities may include computer system 110, one or more processors 112, one or more hardware accelerators 114, storage 116, shape estimation module 118, robot controller 120, robot 130, and sensors 150 illustrated in FIG. 1, first encoder 220(1), second encoder 220(2), third encoder 220(3), feature pooling module 230, 3D encoder 240, and prediction module 250 illustrated in FIG. 2, neural network training system 310, neural network inference system 320, and second neural network 324 illustrated in FIG. 3, The one or more entities may further include, for example, one or more of hardware and/or software described in conjunction with FIG. 1.

Various functions can be carried out by a processor executing instructions stored in memory (e.g., computer-readable, machine-readable) to perform process 500. For example, the instructions may include a computer program persistently stored on magnetic, optical, or flash media. Also, process 500 may be implemented as computer-usable instructions (e.g., macro instruction, micro-instruction) stored on computer storage media or provided by a standalone application, a service, or hosted service (standalone or in combination with another hosted service).

At block 502, the one or more entities may identify an object that is to be moved by one or more robots, which may include an EoAT. The object may include object 140 illustrated in FIG. 4. The object can be one of the various items processed within a distribution center.

At block 504, the one or more entities may capture a plurality of images of the object taken from multiple perspectives. The one or more entities may use various cameras, strategically located near one or more robots, to provide a comprehensive view of the object. In some examples, at least one of the various cameras can move to another location to provide additional viewpoints of the object.

At block 506, the one or more entities may use one or more neural networks to generate one or more 3D representations of the object. The one or more neural networks may include one or more 2D encoders that generate 2D features using the plurality of images. The one or more neural networks may include transformer neural networks that identify, for each voxel of a set of voxels corresponding to a scene that includes the object, locations within the plurality of images where the voxel should be projected and use features within those locations to generate features for each voxel. The one or more neural networks may include one or more 3D encoders that generates additional features for at least one voxel of the set of voxels. The one or more neural networks may include one or more prediction layers that determine whether each voxel of the set of voxels corresponds to the object. The one or more entities may generate a 3D representation (e.g., point cloud, 3D mesh) of the object based on this determination. The 3D representation may indicate the object's shape, orientation, pose, and coordinates, with some indications relative to a robotic arm grabbing or holding it. In some examples, performing block 506 may include performing block 602, block 604, block 606, block 608, block 610, block 612, and block 614 illustrated in FIG. 6.

At block 508, the one or more entities may select a container to place the object using the 3D representation for the object. The one or more entities may further identify how to place the object within the selected containers by comparing the shapes obtained from the 3D representation. At block 510, the one or more entities cause the one or more robots to move the object to the selected container. If there are more objects to generate 3D estimations at block 512, process 500 may move to block 502 to examine additional objects. In some embodiments, one or more of the operations performed in blocks 502, 504, 506, 508, 510, and 512 can be executed in various orders and combinations, including in parallel. As a result of performing block 508, one or more entities (e.g., robot controller 120) can use the 3D estimation to optimize container utilization (e.g., maximize the number of items per container) while preventing damage during placement. Combined with the object's condition or characteristics (e.g., fragility), the 3D estimation can help the one or more entities to determine the optimal location or position for placing items within the container. The one or more entities may also use this 3D estimation to meet packing thresholds (e.g., a specific number of items per container).

FIG. 6 illustrates process 600 performed by a processor to use neural networks to estimate 3D shapes of objects, according to at least one embodiment. Although process 600 is depicted as a series of steps or operations, it will be appreciated that at least one embodiment of process 600 includes altered or reordered steps or operations, or omits certain steps or operations, except where explicitly noted or logically required, such as when an output of one step or operation is used as input for another. One or more entities described in conjunction with FIGS. 1-4 and 8, singly or in any combination, can perform each block of process 600. For example, the one or more entities may include computer system 110, one or more processors 112, one or more hardware accelerators 114, storage 116, shape estimation module 118, robot controller 120, robot 130, and sensors 150 illustrated in FIG. 1, first encoder 220(1), second encoder 220(2), third encoder 220(3), feature pooling module 230, 3D encoder 240, and prediction module 250 illustrated in FIG. 2, neural network training system 310, neural network inference system 320, and second neural network 324 illustrated in FIG. 3, The one or more entities may further include, for example, one or more of hardware and/or software described in conjunction with FIG. 1.

Various functions can be carried out by a processor executing instructions stored in memory (e.g., computer-readable, machine-readable) to perform process 600. For example, the instructions may include a computer program persistently stored on magnetic, optical, or flash media. Also, process 600 may be implemented as computer-usable instructions (e.g., macro instruction, micro-instruction) stored on computer storage media or provided by a standalone application, a service, or hosted service (standalone or in combination with another hosted service).

At block 602, the one or more entities may obtain a set of images of the object taken from multiple viewpoints. The object may include object 140 illustrated in FIG. 1. At block 604, the one or more entities may use one or more 2D encoders (e.g., first encoder 220(1), second encoder 220(2), third encoder 220(3) illustrated in FIG. 2) to generate first features from the set of images. The one or more 2D encoders include ResNet, EfficientNet, MobileNet, DenseNet, VGG, VIT, Swin Transformer, ConvNeXt, CMT, and Variational Autoencoder. In some examples, different 2D encoders can be used for images from the set of images that correspond to various perspectives.

At block 606, the one or more entities (e.g., feature pooling module 230 illustrated in FIG. 2) may, for a voxel of a set of voxels representing at least the object, project the voxel onto each of the set of images to identify corresponding locations for each viewpoint, where the corresponding locations include a subset of first features. The one or more entities may indicate which areas of the set of images to attend or focus when identifying corresponding locations for each viewpoint. The one or more entities may generate an enhanced query vector using the corresponding locations and perform cross-attention based on the query vector. At block 608, the one or more entities may generate second features for the voxel using the subset of first features. The one or more entities may identify surrounding features of the subset of first features and combine them together to generate the second features. If the second features are generated for all voxels of the set of voxels at block 610, process 600 may move to 612. If the second features need to be generated for additional voxels of the set of voxels, the process may move to either 606 or 608.

At block 612, the one or more entities may use one or more 3D encoders (e.g., 3D encoder 240 illustrated in FIG. 2) to generate additional 3D features for at least one voxel of the set of voxels. At block 614, the one or more entities (e.g., prediction module 250 illustrated in FIG. 2) may use the second features and the additional features to determine whether each voxel corresponds to the object. The one or more entities can use this determination to generate various 3D representations (e.g., point cloud, 3D mesh). In some embodiments, one or more of the operations performed in blocks 602, 604, 606, 608, 610, 612, and 614 can be executed in various orders and combinations, including in parallel.

FIG. 7 illustrates process 700 performed by a processor to train neural networks that estimate 3D shapes of objects, according to at least one embodiment. Although process 700 is depicted as a series of steps or operations, it will be appreciated that at least one embodiment of process 700 includes altered or reordered steps or operations, or omits certain steps or operations, except where explicitly noted or logically required, such as when an output of one step or operation is used as input for another. One or more entities described in conjunction with FIGS. 1-4 and 8, singly or in any combination, can perform each block of process 700. For example, the one or more entities may include computer system 110, one or more processors 112, one or more hardware accelerators 114, storage 116, shape estimation module 118, robot controller 120, robot 130, and sensors 150 illustrated in FIG. 1, first encoder 220(1), second encoder 220(2), third encoder 220(3), feature pooling module 230, 3D encoder 240, and prediction module 250 illustrated in FIG. 2, neural network training system 310, neural network inference system 320, and second neural network 324 illustrated in FIG. 3, The one or more entities may further include, for example, one or more of hardware and/or software described in conjunction with FIG. 1.

Various functions can be carried out by a processor executing instructions stored in memory (e.g., computer-readable, machine-readable) to perform process 700. For example, the instructions may include a computer program persistently stored on magnetic, optical, or flash media. Also, process 700 may be implemented as computer-usable instructions (e.g., macro instruction, micro-instruction) stored on computer storage media or provided by a standalone application, a service, or hosted service (standalone or in combination with another hosted service).

At block 702, the one or more entities may train one or more teacher neural networks using images of objects captured from different perspectives to determine whether voxels of a set of voxels are occupied. The one or more teacher neural networks may include VoxNet, ShapeNet, multi-view CNN, Pix2Vox, PointNet, 3D-GAN, among others. The one or more teacher neural networks may perform one or more space carving methods to train the teacher neural networks, where these methods refer to a technique for reconstructing a 3D model from multiple 2D images taken from different viewpoints. Process 700 may proceed to block 706 at block 704 if the teacher neural networks are completely trained. If the training is not completed at block 704, process 700 may return to block 702.

At block 706, the one or more entities may generate training data using the teacher neural networks. The training data may include soft labels, which refer to an indication of a probability distribution over a set of classes or other predictions. At block 708, the neural networks train one or more student neural networks using the generated training data, where the student neural networks use fewer perspectives of the object to determine whether voxels are occupied. Specifically, the one or more entities compared the outputs generated by the one or more teacher neural networks and the one or more student neural networks and use the differences update the weights of the one or more student neural networks. In some embodiments, one or more of the operations performed in blocks 702, 704, 706, and 708 may be performed in various orders and combinations, including in parallel.

Any system or apparatus feature described herein may also be provided as a method feature, and vice versa. System and/or apparatus aspects described functionally (including means-plus-function features) may be expressed alternatively in terms of their corresponding structure, such as a suitably programmed processor and associated memory. It should also be appreciated that particular combinations of the various features described and defined in any aspect of the present disclosure can be implemented, supplied, and used independently.

Any system or apparatus feature described herein can include computer programs and computer program products comprising software code adapted, when executed on a data processing apparatus, to perform any of the methods and/or embody any of the apparatus and system features described herein, including any or all of the component steps of any method. Any system or apparatus feature described herein can also include a computer or computing system (including networked or distributed systems) having an operating system that supports a computer program for carrying out any of the methods described herein and/or embodying any of the apparatus or system features described herein. Any system or apparatus feature described herein can also include computer-readable media having stored thereon any one or more of the computer programs aforesaid. Any system or apparatus feature described herein can include a signal carrying any one or more of the computer programs aforesaid.

Note that, in the context of describing disclosed embodiments, unless otherwise specified, the use of expressions regarding executable instructions (also referred to as code, applications, agents) performing operations that “instructions” do not ordinarily perform unaided (e.g., transmission of data, calculations) denotes that the instructions are being executed by a machine, thereby causing the machine to perform the specified operations.

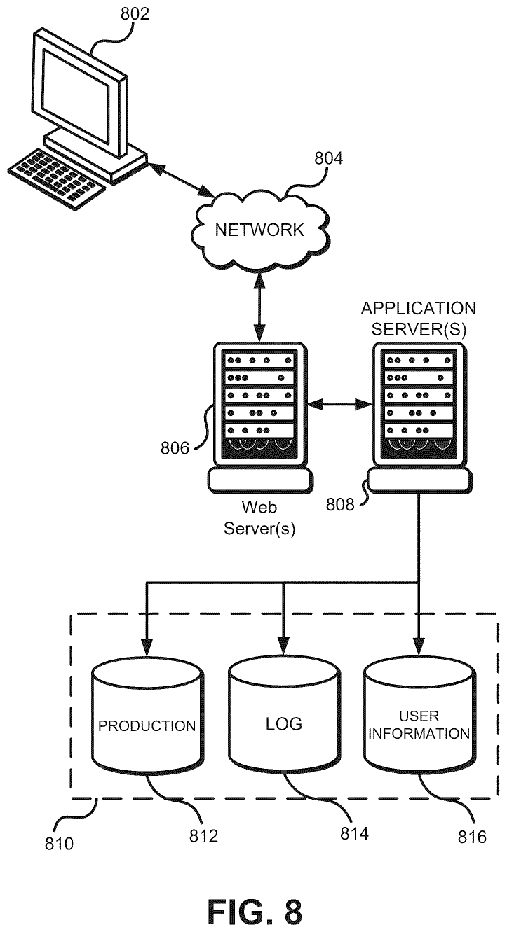

FIG. 8 illustrates aspects of an example system 800 for implementing aspects in accordance with an embodiment. As will be appreciated, although a web-based system is used for purposes of explanation, different systems may be used, as appropriate, to implement various embodiments. In an embodiment, the system includes an electronic client device 802, which includes any appropriate device operable to send and/or receive requests, messages, or information over an appropriate network 804 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 806 for receiving requests and serving content in response thereto, although for other networks an alternative device serving a similar purpose could be used as would be apparent to one of ordinary skill in the art.

In an embodiment, the illustrative system includes at least one application server 808 and a data store 810, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 802 and the application server 808, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 810, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 812 and user information 816, which are used to serve content for the production side. The data store also is shown to include a mechanism for storing log data 814, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 810.

The data store 810, in an embodiment, is operable, through logic associated therewith, to receive instructions from the application server 808 and obtain, update or otherwise process data in response thereto, and the application server 808 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 802. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 800 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 800, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 8. Thus, the depiction of the system 800 in FIG. 8 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

At least one embodiment of the disclosure can be described in view of the following clauses:
1. A method comprising:
generating a plurality of images of an object from different perspectives using a plurality of cameras;
detecting, using one or more neural networks, a first set of features within the plurality of images, wherein each portion of the plurality of two dimensional (2D) images comprise at least one of the first set of features;
mapping, using the one or more neural networks, each voxel in a voxel grid to different portions of the plurality of 2D images based, at least in part, on one or more parameters from the plurality of cameras;
detecting, using the one or more neural networks, a second set of features for each voxel based, at least in part, on a subset of the first set of features that are within the different portions of the plurality of 2D images;
estimating a shape of the object, using the one or more neural networks, by at least determining whether each voxel of the voxel grid is occupied based, at least in part, on the second set of features; and
identifying a space within a container to cause a robot to place the object based, at least in part, on the shape of the object.
2. The method of clause 1, where in detecting the second set of features further comprises:
detecting surroundings features of at least one of the different portions of the plurality of images to perform one or more interpolation operations with the subset of the first set of features, wherein the one or more interpolation operations are to detect the second set of features.
3. The method of clause 1 or 2, wherein projecting each voxel of the 3D voxel grid further comprises:
generating a map that indicates a group of portions of the plurality of images to attend when projecting each voxel of the voxel grid to the different portions of the plurality of images.
4. The method of any of clauses 1-3, further comprising:
identifying surrounding voxels of a voxel of the voxel grid; and using the second set of features that correspond to the surrounding voxels to generate a third set of features for the voxel to determine whether the voxel is occupied.
5. A system comprising:
one or more processors; and
memory that stores computer-executable instructions that, if executed, cause the one or more processors to:
generate first features from images that capture an object to be placed by a robot from different viewpoints;
use one or more neural networks to:
determine distinct portions within the images that are projected from a voxel in a set of voxels;
generate, using one or more neural networks, second features for the voxel of the set of voxels based, at least in part, on one or more subsets of the first features that are within the distinct portions; and
determine, using the one or more neural networks, whether the voxel indicates the object based, at least in part, on the second features.
6. The system of clause 5, wherein the computer-executable instructions further comprise computer-executable instructions that, if executed by the one or more processors, cause the system to:
determine whether to use one or more camera parameters of one or more sensors to perform cross-attention to identify the distinct portions within the images.
7. The system of clause 5 or 6, wherein the computer-executable instructions further comprise computer-executable instructions that, if executed by the one or more processors, cause the system to:
use one or more additional neural networks to generate one or more outputs to train the one or more neural networks.
8 The system of any of clauses 5-7, wherein the computer-executable instructions to determine the distinct portions further comprise computer-executable instructions that, if executed by the one or more processors, cause the system to:
identify one or more markers within a robot that holds the object to determine the distinct portions of the images.
9. The system of any of clauses 5-8, wherein the computer-executable instructions to generate the second features further comprise computer-executable instructions that, if executed by the one or more processors, cause the system to:
identify additional features within other portions of the images that surround at least one of the distinct portions of the images; and
aggregate additional features with the one or more subsets of the first features to generate the second features.
10. The system of any of clauses 5-9, wherein the computer-executable instructions to determine the distinct portions further comprise computer-executable instructions that, if executed by the one or more processors, cause the system to:
indicate where within the images to perform cross-attention to the distinct portions of the images.
11. The system of any of clauses 5-10, wherein the computer-executable instructions to determine whether the voxel indicates the object further comprise computer-executable instructions that, if executed by the one or more processors, cause the system to:
identify additional features corresponding to surrounding voxels of the voxel; and
update the second features based, at least in part, on the additional features.
12. The system of any of clauses 5-11, the computer-executable instructions further comprise computer-executable instructions that, if executed by the one or more processors, cause the system to:
generate 3D estimation of the object based, at least in part, on the determination; and
cause one or more robots to arrange multiple objects within a container that the object is to be placed to increase a number of objects stored within the container.
13. A non-transitory computer-readable storage medium storing thereon executable instructions that, as a result of being executed by one or more processors of a computer system, cause the computer system to at least:
obtaining a set of images including an object captured from various viewpoints;
generating, using one or more neural networks, a second set of features for a voxel of a set of voxels to be used for a three-dimensional representation of the object by at least:
selecting, for a viewpoint, two or more portions of the set of images that are projected from the voxel; and
identifying a first set of features within the two or more portions of the set of images, wherein the first set of features is usable to generate the second set of features; and
generating, using the one or more neural networks, one or more three dimensional (3D) shape estimations of the object by at least determining whether the voxel indicates at least one portion the object based, at least in part, on the set of second features.
14. The non-transitory computer-readable storage medium of clause 13, wherein:
the one or more neural networks are one or more student neural networks; and
the instructions further comprise instructions that, as a result of being executed by the one or more processors, cause the computer system to use one or more teacher neural networks to generate labels to train the one or more neural networks.
15. The non-transitory computer-readable storage medium of clause 13 or 14, wherein the selecting the two or more portions that corresponds to the voxel is based, at least in part, on extrinsic parameters or intrinsic parameters of one or more sensors that generated the set of images.
16. The non-transitory computer-readable storage medium of clauses 13-15, wherein the second set of features is generated based, at least in part, on aggregating the first set of features with other features that surround the portion of the set of images.
17. The non-transitory computer-readable storage medium of clauses 13-16, wherein the instructions further comprise instructions that, as a result of being executed by the one or more processors, cause the computer system to:
cause the one or more neural networks to attend a region within the set of images when selecting, for the viewpoint, the two or more portions are projected from the voxel.
18. The non-transitory computer-readable storage medium of clauses 13-17, wherein the instructions further comprise instructions that, as a result of being executed by the one or more processors, cause the computer system to:
cause an End of Arm Tool (EoAT) to move the object to one of the set of containers to meet one or more packing thresholds for the set of containers based, at least in part, on a comparison between the one or more 3D shape estimations of the object and available space of the set of containers.
19. The non-transitory computer-readable storage medium of clauses 13-18, wherein the one or more neural networks are trained using at least one of Binary Cross Entropy Loss (BCE), Focal Loss, Dice Loss, or Combined Loss.
20. The non-transitory computer-readable storage medium of clauses 13-19, wherein the selection of the portion that corresponds to the voxel is based, at least in part, on one or more portions of EoAT identified within the set of images.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A method comprising:
generating a plurality of images of an object from different perspectives using a plurality of cameras;
detecting, using one or more neural networks, a first set of features within the plurality of images, wherein each portion of the plurality of two dimensional (2D) images comprise at least one of the first set of features;
mapping, using the one or more neural networks, each voxel in a voxel grid to different portions of the plurality of 2D images based, at least in part, on one or more parameters from the plurality of cameras;
detecting, using the one or more neural networks, a second set of features for each voxel based, at least in part, on a subset of the first set of features that are within the different portions of the plurality of 2D images;
estimating a shape of the object, using the one or more neural networks, by at least determining whether each voxel of the voxel grid is occupied based, at least in part, on the second set of features; and
identifying a space within a container to cause a robot to place the object based, at least in part, on the shape of the object.

2. The method of claim 1, wherein detecting the second set of features further comprises:
detecting surrounding features of at least one of the different portions of the plurality of images to perform one or more interpolation operations with the subset of the first set of features, wherein the one or more interpolation operations are to detect the second set of features.

3. The method of claim 1, wherein projecting each voxel of the 3D voxel grid further comprises:
generating a map that indicates a group of portions of the plurality of images to attend when projecting each voxel of the voxel grid to the different portions of the plurality of images.

4. The method of claim 1, further comprising:
identifying surrounding voxels of a voxel of the voxel grid; and
using the second set of features that correspond to the surrounding voxels to generate a third set of features for the voxel to determine whether the voxel is occupied.

5. A system comprising:
one or more processors; and
memory that stores computer-executable instructions that, if executed, cause the one or more processors to:
generate first features from images that capture an object to be placed by a robot from different viewpoints;
use one or more neural networks to:
determine distinct portions within the images that are projected from a voxel in a set of voxels;
generate, using one or more neural networks, second features for the voxel of the set of voxels based, at least in part, on one or more subsets of the first features that are within the distinct portions; and
determine, using the one or more neural networks, whether the voxel indicates the object based, at least in part, on the second features.

6. The system of claim 5, wherein the computer-executable instructions further comprise computer-executable instructions that, if executed by the one or more processors, cause the system to:
determine whether to use one or more camera parameters of one or more sensors to perform cross-attention to identify the distinct portions within the images.

7. The system of claim 5, wherein the computer-executable instructions further comprise computer-executable instructions that, if executed by the one or more processors, cause the system to:
use one or more additional neural networks to generate one or more outputs to train the one or more neural networks.

8. The system of claim 5, wherein the computer-executable instructions to determine the distinct portions further comprise computer-executable instructions that, if executed by the one or more processors, cause the system to:
identify one or more markers within a robot that holds the object to determine the distinct portions of the images.

9. The system of claim 5, wherein the computer-executable instructions to generate the second features further comprise computer-executable instructions that, if executed by the one or more processors, cause the system to:
identify additional features within other portions of the images that surround at least one of the distinct portions of the images; and
aggregate additional features with the one or more subsets of the first features to generate the second features.

10. The system of claim 5, wherein the computer-executable instructions to determine the distinct portions further comprise computer-executable instructions that, if executed by the one or more processors, cause the system to:
indicate where within the images to perform cross-attention to the distinct portions of the images.

11. The system of claim 5, wherein the computer-executable instructions to determine whether the voxel indicates the object further comprise computer-executable instructions that, if executed by the one or more processors, cause the system to:
identify additional features corresponding to surrounding voxels of the voxel; and
update the second features based, at least in part, on the additional features.

12. The system of claim 5, the computer-executable instructions further comprise computer-executable instructions that, if executed by the one or more processors, cause the system to:
generate 3D estimation of the object based, at least in part, on the determination; and
cause one or more robots to arrange multiple objects within a container that the object is to be placed to increase a number of objects stored within the container.

13. A non-transitory computer-readable storage medium storing thereon executable instructions that, as a result of being executed by one or more processors of a computer system, cause the computer system to at least:
obtaining a set of images including an object captured from various viewpoints;
generating, using one or more neural networks, a second set of features for a voxel of a set of voxels to be used for a three-dimensional representation of the object by at least:
selecting, for a viewpoint, two or more portions of the set of images that are projected from the voxel; and
identifying a first set of features within the two or more portions of the set of images, wherein the first set of features is usable to generate the second set of features; and
generating, using the one or more neural networks, one or more three dimensional (3D) shape estimations of the object by at least determining whether the voxel indicates at least one portion the object based, at least in part, on the set of second features.

14. The non-transitory computer-readable storage medium of claim 13, wherein:
the one or more neural networks are one or more student neural networks; and
the instructions further comprise instructions that, as a result of being executed by the one or more processors, cause the computer system to use one or more teacher neural networks to generate labels to train the one or more neural networks.

15. The non-transitory computer-readable storage medium of claim 13, wherein the selecting the two or more portions that corresponds to the voxel is based, at least in part, on extrinsic parameters or intrinsic parameters of one or more sensors that generated the set of images.

16. The non-transitory computer-readable storage medium of claim 13, wherein the second set of features is generated based, at least in part, on aggregating the first set of features with other features that surround the portion of the set of images.

17. The non-transitory computer-readable storage medium of claim 13, wherein the instructions further comprise instructions that, as a result of being executed by the one or more processors, cause the computer system to:
cause the one or more neural networks to attend a region within the set of images when selecting, for the viewpoint, the two or more portions are projected from the voxel.

18. The non-transitory computer-readable storage medium of claim 13, wherein the instructions further comprise instructions that, as a result of being executed by the one or more processors, cause the computer system to:
cause an End of Arm Tool (EoAT) to move the object to one of the set of containers to meet one or more packing thresholds for the set of containers based, at least in part, on a comparison between the one or more 3D shape estimations of the object and available space of the set of containers.

19. The non-transitory computer-readable storage medium of claim 13, wherein the one or more neural networks are trained using at least one of Binary Cross Entropy Loss (BCE), Focal Loss, Dice Loss, or Combined Loss.

20. The non-transitory computer-readable storage medium of claim 13, wherein the selection of the portion that corresponds to the voxel is based, at least in part, on one or more portions of EoAT identified within the set of images.
